(19) United States
(12) Patent Application Publication
(10) Pub. No.: US 2020/0089225 A1
(43) Pub. Date: Mar. 19, 2020

(54) CONTROL SYSTEM OF VEHICLE AND CONTROL METHOD OF VEHICLE

(71) Applicant: Honda Motor Co.,Ltd., Tokyo (JP)

(72) Inventors: Masayuki SADAKIYO, Saitama (JP); Akiko NAKAGAWARA, Saitama (JP); Takuro SHIMIZU, Saitama (JP)

(73) Assignee: Honda Motor Co.,Ltd., Tokyo (JP)

(21) Appl. No.: 16/568,213

(22) Filed: Sep. 11, 2019

(30) Foreign Application Priority Data
Sep. 18, 2018 (JP) 2018-173975

(51) Int. Cl. G05D 1/00

(52) U.S. Cl. CPC G05D 1/0061; G05D 1/0231; G05D 2201/0213; G05D 1/0088

(57) ABSTRACT

The control method of a vehicle is a method to control the vehicle at the time of switching from the automatic driving to the manual driving, changes driving force distribution of the vehicle to right and left driving force distribution, and gradually or stepwisely switches to the manual driving while returning the right and left driving force distribution to original driving force distribution. In addition, a steering amount at the time of the automatic driving is stored when a requirement of switching from the automatic driving to the manual driving is issued, the driving force distribution of the vehicle is changed to the right and left driving force distribution based on the steering amount at the time of the automatic driving, and the automatic driving is gradually or stepwisely switched to the manual driving while the right and left driving force distribution is returned to the original driving force distribution.

### CROSS-REFERENCE TO RELATED APPLICATION

This application claims the priority benefits of Japan Patent Application No. 2018-173975, filed on Sep. 18, 2018. The entirety of the above-mentioned patent application is hereby incorporated by reference herein and made a part of this specification.

### BACKGROUND

### Technical Field

The disclosure relates to a control system and a control method of a vehicle capable of automatic driving/manual driving, in particular, to a system and a method for controlling a vehicle at the time of switching from automatic driving to manual driving.

### Related Art

Conventionally, a vehicle behavior control apparatus which improves travel stability of a vehicle is proposed and put into practical use.

For example, the vehicle behavior control apparatus (a vehicle posture stability control apparatus) in patent literature 1 includes: a yaw moment generation apparatus, which generates a yaw moment in the vehicle; a disturbance yaw moment detection part, which obtains a disturbance yaw moment amount acting on the vehicle; a disturbance suppression yaw moment calculation part, which obtains a disturbance suppression yaw moment amount based on the disturbance yaw moment amount detected by the disturbance yaw moment detection part; a control command value calculation part, which obtains a control command value for generating the disturbance suppression yaw moment amount calculated by the disturbance suppression yaw moment calculation part in the yaw moment generation apparatus; a non-steering state detection part, which detects a non-steering state of the vehicle; and a vehicle posture control part, which outputs, when the non-steering state of the vehicle is detected by the non-steering state detection part, the control command value calculated by the control command value calculation part to the yaw moment generation apparatus.

In addition, the vehicle behavior control apparatus (a drive support apparatus) in patent literature 2 includes: a cause information acquirement part, which acquires information relating to causes of vehicle shake, such as an earthquake, a crosswind, a road surface state, air pressure of a tire, or the like; an impact degree calculation part, which calculates, based on the cause information acquired by the cause information acquirement part, an impact degree of each cause to the vehicle shake; and a recommended action instruction part, which determines and instructs an action the driver should take based on the impact degree of each cause calculated by the impact degree calculation part.

### LITERATURE OF RELATED ART

### Patent Literature

[Patent literature 1] Japanese Laid-Open No. 2002-211380

[Patent literature 2] Japanese Laid-Open No. 2009-143353

On the other hand, even when the conventional vehicle behavior control apparatuses in patent literature 1 and patent literature 2 are included, if there is a deviation between a steer⋅AP (Auto Perfect Drive) operation by automatic driving and an intention of a driver who carries out the operation manually at the time of switching from automatic driving to manual driving, there is a risk that the vehicle behavior is disturbed and sometimes an accident is caused.

Specifically, for example, when a great yaw rate and a rapid yaw rate fluctuation occur due to a crosswind (lateral acceleration/lateral weight) in the automatic driving, and a requirement of switching from the automatic driving to the manual driving is issued, if the steer⋅AP operation by the automatic driving deviates from the intention of the driver, there is a risk that the driver performs a sudden handle operation or an excessive handle operation and the vehicle behavior is disturbed.

In addition, when a requirement of switching to the manual driving is issued during circular traveling in the automatic driving, if a deviation from the intention of the driver also occurs, there is a risk that the driver performs a sudden handle operation or an excessive handle operation and the vehicle behavior is disturbed.

Furthermore, when obstacles such as falling objects are detected on the road and requirement of switching from the automatic driving to the manual driving is issued, there is also a risk that the driver performs a sudden handle operation or an excessive handle operation to avoid the obstacles and the vehicle behavior is disturbed.

### SUMMARY

The disclosure provides a control system of a vehicle and a control method of a vehicle, which are capable of avoiding/suppressing the disturbance of the vehicle behavior caused by the deviation between the steer⋅AP operation by the automatic driving and the intention of the driver at the time of switching from the automatic driving to the manual driving.

The present inventors found that the disturbance of the vehicle behavior caused by the deviation between the steer⋅AP operation by the automatic driving and the intention of the driver can be avoided/suppressed by gradually (or stepwisely) switching from the automatic driving to the manual driving, and the disclosure is thus achieved. More specifically, the disclosure provides the following.

(1) The disclosure is a control system of a vehicle, which is a system for controlling a vehicle at the time of switching from automatic driving to manual driving and is characterized in including: an abnormality determination portion, which determines whether the vehicle is subject to disturbance and in an abnormal state during the automatic driving; a manual driving switching requirement portion, which issues a manual driving switching requirement when the abnormality determination portion determines the abnormal state; a storage portion, which stores a steering amount at the time of the automatic driving when the requirement of switching to the manual driving is issued from the manual driving switching requirement portion; a driving force distribution control portion, which controls, when the requirement of switching to the manual driving is issued from the manual driving switching requirement portion, switching a driving force of the vehicle to right and left drive distribution according to the steering amount at the time of the automatic driving stored in the storage portion; a right and left distribution/manual driving transition time measurement portion, which measures a manual assist release time set in advance from a stage in which the driving force of the vehicle is switched to the right and left drive distribution by the driving force distribution control portion; and a driving switching control portion, which switches the automatic driving and the manual driving to each other, wherein the driving force distribution control portion and the driving switching control portion are configured that a return control which returns the right and left drive distribution to original driving force distribution is gradually or stepwisely carried out in a period that the manual assist release time has elapsed from a moment when the driving force of the vehicle is controlled to be switched to the right and left drive distribution by the driving force distribution control portion, and the control in which the manual driving steering is reflected in the behavior of the vehicle is gradually or stepwisely carried out.

(2) The disclosure is a control method of a vehicle, which is a method to control a vehicle at the time of switching from automatic driving to manual driving and is characterized in changing driving force distribution of the vehicle to right and left driving force distribution, and gradually or stepwisely switching to the manual driving while returning the right and left driving force distribution to original driving force distribution.

(3) The disclosure is the control method of a vehicle according to (2), which is desirable that a steering amount at the time of the automatic driving is stored when a requirement of switching from the automatic driving to the manual driving is issued, the driving force distribution of the vehicle is changed to the right and left driving force distribution based on the steering amount at the time of the automatic driving, and in a period that a time define in advance has elapsed from a moment when the driving force distribution of the vehicle is changed to the right and left driving force distribution, the automatic driving is gradually or stepwisely switched to the manual driving while the right and left driving force distribution is returned to the original driving force distribution.

In the disclosures of (1), (2), and (3), the driving force is switched to the right and left driving force distribution from the automatic driving steering, and switching gradually or stepwisely from a state of the right and left driving force distribution to the manual driving steering is controlled, and thereby the disturbance of the vehicle behavior can be avoided/suppressed even if the driver performs a sudden handle operation or an excessive handle operation when requirement of switching from the automatic driving to the manual driving is issued.

According to the disclosure, the disturbance of the vehicle behavior caused by the deviation between the steer⋅AP operation by the automatic driving and the intention of the driver can be avoided/suppressed by switching gradually or stepwisely from the automatic driving to the manual driving, and a vehicle with higher safety and reliability can be provided by realizing such advanced vehicle control at the time of switching from the automatic driving to the manual driving.

### BRIEF DESCRIPTION OF THE DRAWINGS

FIG. 1 is a diagram showing a control system of a vehicle according to one embodiment of the disclosure.

FIG. 2 is a flow diagram showing a control method of a vehicle according to one embodiment of the disclosure.

FIG. 3 is a diagram showing a time chart of the control method of a vehicle according to one embodiment of the disclosure.

### DESCRIPTION OF THE EMBODIMENTS

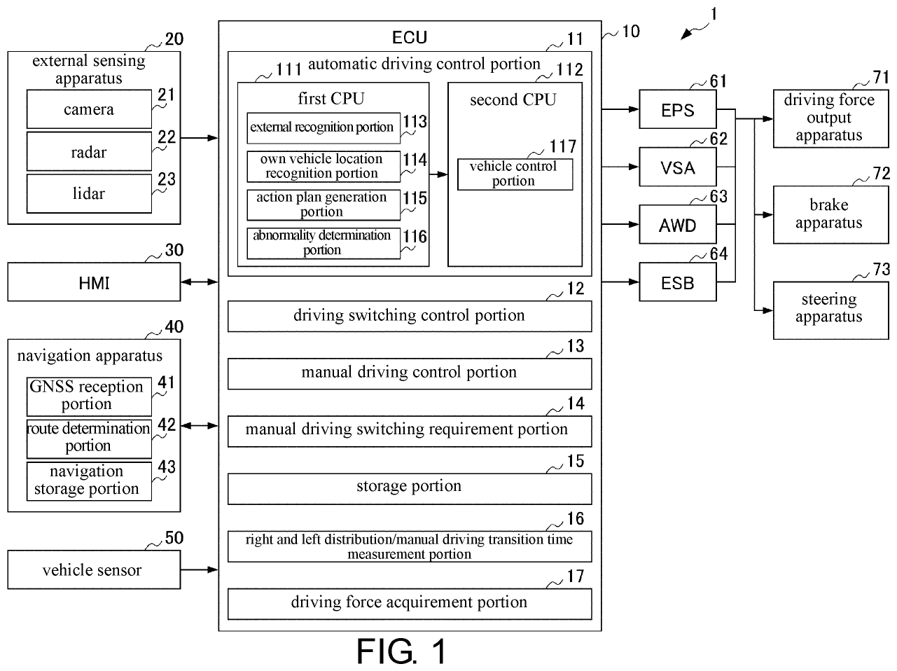

In the following, a control system of a vehicle and a control method of a vehicle according to one embodiment of the disclosure are described with reference to FIG. 1 to FIG. 3. Furthermore, the embodiment relates to a system and a method for controlling a vehicle at the time of switching from automatic driving to manual driving.

The vehicle of the embodiment is, for example, an electric automatic vehicle, an engine vehicle, a hybrid vehicle, a fuel cell vehicle or the like capable of automatic driving/manual driving equivalent to level 3 defined by Ministry of Land, Infrastructure, Transport and Tourism of Japan.

In addition, as shown in FIG. 1, a vehicle control system (a control system of a vehicle) 1 mounted to the vehicle of the embodiment includes an ECU (Electronic Control Unit) 10, an external sensing apparatus 20, an HMI (Human Machine Interface) 30, a navigation apparatus 40, a vehicle sensor 50, an EPS (Electric Power Steering) 61, a VSA (Vehicle Stability Assist) 62, an AWD (All Wheel Drive) 63, an ESB (Electric Servo Brake) 64, a driving force output apparatus 71, a brake apparatus 72, and a steering apparatus 73.

The external sensing apparatus 20 includes a camera 21, a radar 22, and a lidar 23.

At least one camera 21 is arranged at any place of the own vehicle and captures images of the surroundings of the own vehicle to acquire image information. The camera 21 is a monocular camera or a stereo camera, and for example a digital camera using a solid-state imaging element, such as a CCD (Charge Coupled Device), a CMOS (Complementary Metal Oxide Semiconductor) or the like, is used.

At least one radar 22 is arranged at any place of the own vehicle and detects a location (a distance and an orientation) of an object existing in the surroundings of the own vehicle. Particularly, the radar 22 irradiates electromagnetic waves such as millimeter waves to the surroundings of the vehicle and detects reflected waves of the irradiated electromagnetic waves reflected by the object, thereby detecting the location of the object.

At least one lidar 23 is arranged at any place of the own vehicle and detects the location (the distance and the orientation) or nature of the object existing in the surroundings of the own vehicle. Particularly, the lidar 23 irradiates, in pulses, short-wavelength electromagnetic waves (electromagnetic waves such as ultraviolet light, visible light, and near infrared light) shorter than the millimeter waves to the surroundings of the vehicle, and detects scattered waves of the irradiated electromagnetic waves scattered by the object, thereby detecting the location and the nature of the object existing at a further distance than the radar 22.

The external sensing apparatus 20 functions as an ADAS (Advanced Driver Assistance Systems). Particularly, the external sensing apparatus 20 comprehensively evaluates, by sensor fusion technology, each information acquired by the camera 21, the radar 22 and the lidar 23 or the like, and outputs more accurate information to the ECU 10 described later in detail.

The HMI 30 is an interface which presents various information to the driver or the like and accepts input operations performed by the driver or the like. The HMI 30 includes, for example, a display apparatus, a seat belt apparatus, a handle touch sensor, a driver monitor camera, and various operation switches or the like, any of which is not shown in the diagram.

The display apparatus is, for example, a touch panel type display apparatus which displays an image and accepts operations performed by the driver or the like. The seat belt apparatus includes a seat belt pretensioner for example, and vibrates the seat belt to inform and warn the driver for example when switching from automatic driving to manual driving is executed regardless of the driver's intention due to vehicle failure or the like. The handle touch sensor is arranged on a steering wheel of the vehicle, and detects contact of the driver with the steering wheel and a pressure at which the driver holds the steering wheel. The driver monitor camera captures images of the face and the upper body of the driver. The various operation switches include, for example, a GUI (Graphical User Interface) type or a mechanical type automatic driving switching switch or the like for instructing start and stop of the automatic driving. In addition, the HMI 30 may also include various communication apparatuses having a function of communicating with the outside.

The navigation apparatus 40 includes a GNSS (Global Navigation Satellite System) reception portion 41, a route determination portion 42, and a navigation storage portion 43. In addition, the navigation apparatus 40 includes, within the HMI 30, a display apparatus or a speaker, operation switches or the like for the driver to use the navigation apparatus 40.

The GNSS reception portion 41 specifies the location of the vehicle based on a reception signal from a GNSS satellite. However, the location of the vehicle may also be specified according to information acquired from the vehicle sensor 50 described later in detail.

The route determination portion 42 determines, with reference to map information stored in the navigation storage portion 43 described later in detail, for example a route from the location of the own vehicle specified by the GNSS reception portion 41 to a destination input by the driver or the like. The route determined by the route determination portion 42 is guided to the driver or the like by the display apparatus, the speaker or the like in the HMI 30.

The navigation storage portion 43 stores a highly accurate map information MPU (Map Position Unit). The map information includes, for example, a type of a road, the number of lanes of a road, locations of emergency parking zones, widths of lanes, slopes of a road, a location of a road, curvature of lane curves, merging and branching point locations of lanes, information of road signs or the like, location information of intersections, information about existence of a traffic light, location information of stop lines, traffic jam information, information of other vehicles, and the like.

Furthermore, the navigation apparatus 40 may also be configured, for example, by a terminal apparatus, such as a smartphone, a tablet terminal or the like. In addition, the navigation apparatus 40 includes various cellular networks, a vehicle mounted communication unit TCU (Telematics Communication Unit) or the like, any of which is not shown in the diagram, and is capable of transmission and reception with cloud servers or the like. In this way, the vehicle location information or the like is transmitted to the outside and the map information is updated as needed.

The vehicle sensor 50 includes a plurality of sensors for detecting various behaviors of the own vehicle. For example, the vehicle sensor 50 includes a vehicle speed sensor detecting a speed of the own vehicle (vehicle speed), a wheel speed sensor detecting a speed of each wheel of the own vehicle, a longitudinal acceleration sensor detecting acceleration and deceleration of the own vehicle, a lateral acceleration sensor detecting lateral acceleration of the own vehicle, a yaw rate sensor detecting a yaw rate of the own vehicle, an orientation sensor detecting a direction of the own vehicle, a slope sensor detecting a slope of the own vehicle, and the like.

In addition, the vehicle sensor 50 includes a plurality of sensors detecting operation amounts of various operation devices. For example, the vehicle sensor 50 includes an accelerator pedal sensor detecting a treading (an opening degree) amount of an accelerator pedal, a steering angle sensor detecting the operation amount of the steering wheel (a steering angle), a torque sensor detecting a steering torque, a brake pedal sensor detecting a treading amount of a brake pedal, a shift sensor detecting a location of a shift lever, and the like.

The EPS 61 is a so-called electric power steering apparatus. The EPS 61 includes an EPS⋅ECU not shown in the diagrams, and changes a direction of the wheel (the steering wheel) by controlling the steering apparatus 73 described later according to a control command output from the ECU 10 described later in detail.

The VSA 62 is a so-called vehicle behavior stabilization control apparatus. The VSA 62 includes a VSA⋅ECU not shown in the diagram, and has an ABS (antilock brake system) function of preventing lock of the wheels during a braking operation, a TCS (traction control system) function of preventing idling of the wheels during acceleration, a function of suppressing side slips during turning or the like, and a function of carrying out emergency braking control regardless of a braking operation of the driver during collision of the own vehicle. In order to realize these functions, the VSA 62 supports behavior stabilization of the vehicle by adjusting a braking fluid pressure generated by the ESB 64 described later.

The VSA 62 controls the brake apparatus 72 described later based on the vehicle speed, the steering angle, the yaw rate, the lateral acceleration and the like detected by the vehicle speed sensor, the steering angle sensor, the yaw rate sensor and the lateral acceleration sensor. Particularly, the VSA 62 controls a braking force of each wheel respectively to improve travel stability by controlling a fluid pressure unit which supplies the brake fluid pressure to a brake cylinder of each of the front, rear, left and right wheels.

The AWD 63 is a so-called four-wheel driving force flexible control system and functions as the driving force distribution control portion. That is, the AWD 63 includes an AWD⋅ECU not shown in the diagram and flexibly controls driving force distribution of the front and rear wheels and the right and the left of the rear wheels. Particularly, the AWD 63 changes the driving force distribution between the front, rear, right and left wheels by controlling a magnetic clutch, a drive motor or the like within the front, rear, right and left driving force distribution unit based on the vehicle speed, the steering angle, the yaw rate, the lateral acceleration and the like detected by the vehicle speed sensor, the steering angle sensor, the yaw rate sensor and the lateral acceleration sensor.

In addition, the AWD 63 functioning as a driving force distribution control portion distributes, for example when the automatic driving control is forcibly switched to manual driving control by the driving switching control portion 12 regardless of an intention of the driver, the driving force is distributed based on information at the time of the automatic driving stored in a storage portion 15. The details are described later.

The ESB 64 includes an ESB⋅ECU not shown in the diagram, and generates braking forces on the wheels by controlling the brake apparatus 72 described later according to the control command output from the ECU 10 described later in detail.

The driving force output apparatus 71 is configured by an electric motor serving as a driving source of the own vehicle and the like. The driving force output apparatus 71 generates a travel driving force (a torque) under which the own vehicle travels according to the control command output from the ECU 10 described later in detail and transmits the travel driving force to each wheel via a transmission.

The brake apparatus 72 is configured, for example, by an electric servo brake combined with a hydraulic brake. The brake apparatus 72 brakes the wheels according to the control command output from the ECU 10.

The steering apparatus 73 is controlled by the EPS 61 and changes the direction of the wheel (the steering wheel).

Next, the ECU 10 included in the vehicle control system 1 according to the embodiment is described in detail.

As shown in FIG. 1, the ECU 10 includes an automatic driving control portion 11, a driving switching control portion 12, a manual driving control portion 13, a motored driving switching requirement portion 14, the storage portion 15, a right and left distribution/manual driving transition time measurement portion 16, and a driving force acquirement portion 17.

The automatic driving control portion 11 includes a first CPU 111 and a second CPU 112.

The first CPU 111 includes an external recognition portion 113, a own vehicle location recognition portion 114, an action plan generation portion 115, and an abnormality determination portion 116.

The external recognition portion 113 recognizes an external object (a recognition target) and recognizes its location based on the various information acquired by the external sensing apparatus 20. Particularly, the external recognition portion 113 recognizes obstacles, road shapes, traffic lights, guardrail, telephone poles, surrounding vehicles (including a travel state such as a speed, an acceleration or the like and a parking state), lane marks, walkers and the like and recognizes their locations.

The own vehicle location recognition portion 114 recognizes a current location and a posture of the own vehicle based on the location information of the own vehicle measured by the navigation apparatus 40 and the various sensor information detected by the vehicle sensor 50. Particularly, the own vehicle location recognition portion 114 recognizes a travel lane in which the own vehicle is travelling, and recognizes a relative location and posture of the own vehicle with respect to this travel lane by comparing the map information and the images acquired by the camera 21.

The action plan generation portion 115 generates an action plan of the automatic driving until the own vehicle reaches the destination or the like. Specifically, the action plan generation portion 115 generates, based on the external information recognized by the external recognition portion 113 and the own vehicle location information recognized by the own vehicle location recognition portion 114, the action plan of the automatic driving in a manner of being capable of traveling on the route determined by the route determination portion 42 while dealing with the situation of the own vehicle and the surrounding situation.

Specifically, the action plan generation portion 115 generates a target track along which the own vehicle is about to travel. The action plan generation portion 115 generates a plurality of target track candidates and selects an optimal target track at that time from the viewpoint of safety and efficiency. In addition, the action plan generation portion 115 generates, for example, an action plan for stopping the own vehicle at a safe location (an emergency parking zone, a roadside zone, a road shoulder, a parking area or the like) when the abnormality determination portion 116 described later in detail determines that an occupant or the own vehicle is in an abnormal state.

The abnormality determination portion 116 determines whether at least one of the driver and the own vehicle is in the abnormal state. The abnormal state of the driver means, for example, a deterioration in physical condition, and includes a state in which the occupant is sleeping or a state of unconsciousness due to illness or the like. In addition, the abnormal state of the own vehicle means failure or the like of the own vehicle.

Specifically, the abnormality determination portion 116 determines the abnormal state of the driver by analyzing the images acquired by the driver monitor camera. In addition, the abnormality determination portion 116 determines that the driver is in the abnormal state if the manual driving operation of the driver is not detected even though the driver is notified of warning by display, sound, seat belt vibration or the like for predetermined times or more when the automatic driving is forcibly switched to manual driving regardless of the intention of the driver due to, for example, the failure or the like of the own vehicle. The manual driving operation of the driver is detected by the handle touch sensor, the accelerator pedal sensor, the brake pedal sensor and the like.

In addition, the abnormality determination portion 116 determines that it is also in an abnormal state when the own vehicle in the automatic driving was subject to a disturbance at a degree of impacting the automatic driving or a greater degree, for example, generation of a great yaw rate, a rapid yaw rate fluctuation, and obstacles or the like on the road are detected at the time of the automatic driving, and/or when the own vehicle in the automatic driving is subject to a disturbance at a degree of impacting the automatic driving or a greater degree.

Furthermore, the abnormality determination portion 116 detects presence or absence of the failure of the own vehicle based on the various sensor information acquired by the vehicle sensor 50 and the like, and determines that the own vehicle is in an abnormal state when failure is detected.

The second CPU 112 includes a vehicle control portion 117. The external information, the own vehicle location information, the action plan and the abnormality information acquired by the first CPU 111 are input to the vehicle control portion 117.

The vehicle control portion 117 begins/stops the automatic driving according to an automatic driving begin/stop signal input from the automatic driving switching switch. In addition, the vehicle control portion 117 controls the driving force output apparatus 71, the brake apparatus 72 and the steering apparatus 73 via the EPS 61, the VSA 62, the AWD 63, the ESB 64 and the like so that the own vehicle travels at the target speed along the target track generated by the action plan generation portion 115.

The driving switching control portion 12 alternately switches each driving mode of the automatic driving and the manual driving according to the signal input from the automatic driving switching switch. The driving switching control portion 12 switches the driving mode based on, for example, operations of instructing acceleration, deceleration or steering of the accelerator pedal, the brake pedal, the steering wheel or the like. In addition, the driving switching control portion 12 executes the switching from the automatic driving to the manual driving in vicinity of a predefined end location of the automatic driving or the like set by the action plan generated by the action plan generation portion 115.

The manual driving switching requirement portion 14 issues a manual driving switching requirement when the abnormality determination portion 116 determines the disturbance to the own vehicle, such as the failure of the own vehicle, the generation of the great yaw rate, the rapid yaw rate fluctuation, and the obstacles such as the falling objects or the like on the road which are detected, to be an abnormal state. The manual driving switching requirement issued from the manual driving switching requirement portion 14 is received by the driving switching control portion 12, implementation of the automatic driving control is avoided, and the switching to the manual driving control is performed.

The storage portion 15 stores a steering amount (a steering correction amount) at the time of the automatic driving when the requirement of switching to the manual driving is issued from the manual driving switching requirement portion 14.

When the manual driving switching requirement is issued from the manual driving switching requirement portion 14, the driving switching control portion 12 transmits the command to the AWD 63 functioning as the driving force distribution control portion. The AWD 63 which received the command controls, according to the steering amount (the steering correction amount) at the time of the automatic driving stored in the storage portion 15, to switch the driving force of the vehicle to right and left distribution (right and left drive distribution). Furthermore, the AWD 63 gradually or stepwisely carries out return control which returns the right and left distribution to original driving force distribution as a time set by the right and left distribution/manual driving transition time measurement portion 16 described later has elapsed from the implementation of the control of the switching to the right and left distribution.

The right and left distribution/manual driving transition time measurement portion 16 sets and measures the time (manual assist release time, standby time) from a moment when the requirement of switching to the manual driving is issued from the manual driving switching requirement portion 14 and the AWD 63 switches, in a state of automatic driving steering, the driving force distribution to the right and left distribution to the moment when the right and left distribution is gradually or stepwisely switched to the manual driving steering to be completely switched to the manual driving steering.

The driving force acquirement portion 17 calculates and acquires a requirement driving force of the vehicle. Particularly, the driving force acquirement portion 17 acquires, using a map or the like stored in advance and based on the vehicle speed acquired by the vehicle speed sensor, an operation amount of the accelerator pedal acquired by the accelerator pedal sensor, an operation amount of the brake pedal acquired by the brake pedal sensor and the like, the required driving force output from an output shaft.

Here, as described above, for example, when the disturbance of crosswind (a lateral acceleration/a lateral weight) is received in the automatic driving and the great yaw rate is generated, or the rapid yaw rate fluctuation is generated and the requirement of switching from the automatic driving to the manual driving is issued, or when the requirement of the switching to manual driving is issued due to the disturbance during circular traveling in the automatic driving, or when the disturbance of the obstacles such as the falling objects on the road is found during the automatic driving and the requirement of switching from the automatic driving to the manual driving is issued, there is a risk that the driver performs a sudden handle operation or an excessive handle operation, the vehicle behavior is disturbed and sometimes an accident is caused.

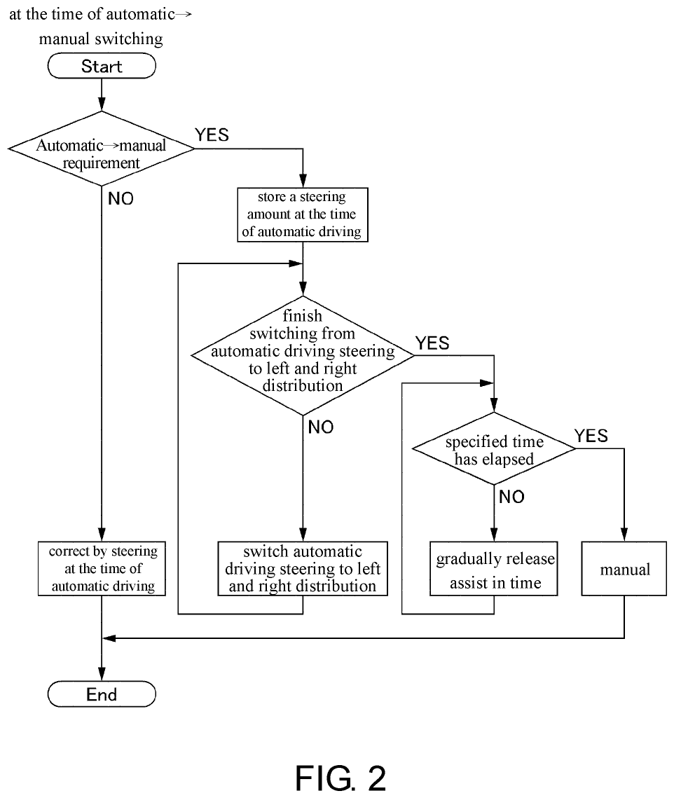

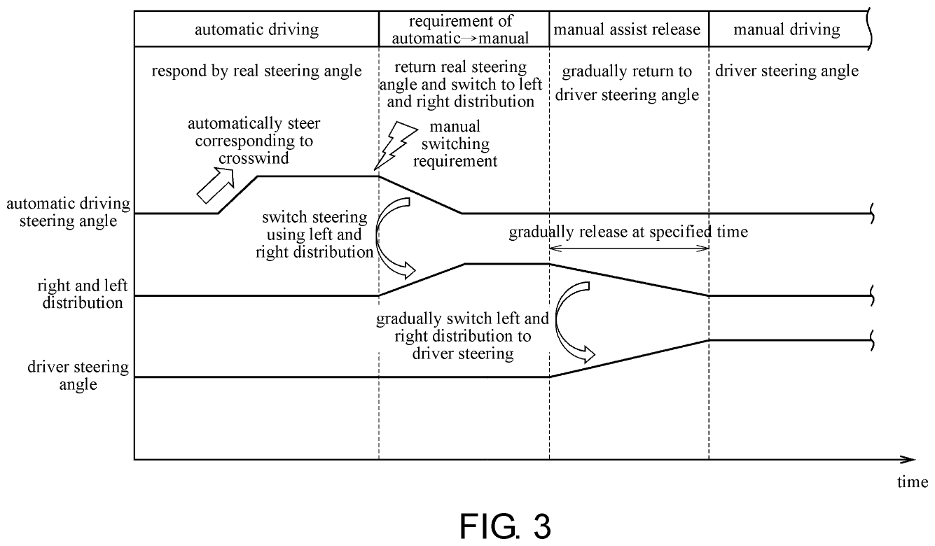

In contrast, in the control system of a vehicle and the control method of a vehicle of the embodiment, as shown in FIG. 2 and FIG. 3 (with reference to FIG. 1), when the disturbance of the crosswind is received during the automatic driving and generation of the great yaw rate and the rapid yaw rate fluctuation is detected, or when there are the disturbance obstacles on the road, the abnormality determination portion 116 detects it as an abnormal state.

Furthermore, in the embodiment, the case in which the disturbance of the crosswind is received during the automatic driving is described below as an example.

When the crosswind is received during the automatic driving, and the generation of the great yaw rate and the rapid yaw rate fluctuation are detected, in the control system of a vehicle and the control method of a vehicle of the embodiment, it is determined whether the disturbance of this crosswind has an impact that threatens the safety of the own vehicle in the automatic driving.

Then, when it is determined that the switching from the automatic driving to the manual driving is not necessary, an automatic driving mode is maintained, a driving situation is modified by steering control at the time of the automatic driving, and the automatic driving is continued while a preferable driving state is ensured corresponding to the disturbance of the crosswind.

On the other hand, when it is determined that the switching from the automatic driving to the manual driving is necessary, that is, when it is determined to be an abnormal state, the requirement of switching from the automatic driving to the manual driving is issued by the manual driving switching requirement portion 14. In addition, the requirement of the switching to the manual driving is issued, and the steering correction amount/the steering amount corresponding to the disturbance of the crosswind at the time of the automatic driving is stored in the storage portion 15.

Furthermore, the driving switching control portion 12, which received the manual driving switching requirement from the manual driving switching requirement portion 14, sends the command to the AWD 63 functioning as the driving force distribution control portion, and the AWD 63 which received this command controls to switch the driving force of the vehicle to the right and left distribution in order to reflect the steering correction amount/the steering amount at the time of the automatic driving stored in the storage portion 15.

In addition, the right and left distribution/manual driving transition time measurement portion 16 starts to measure the time from the moment when the driving force distribution is switched to the right and left distribution by the AWD 63, and the AWD 63 gradually or stepwisely returns, in a period until the manual assist release time set in advance by the right and left distribution/manual driving transition time measurement portion 16 has elapsed, the right and left distribution to the original drive distribution in order to return a real steering amount at the time of the automatic driving (the steering correction amount at the time of the automatic driving that is stored) to the original.

Here, the driving switching control portion 12 receives manual driving switching requirement from the manual driving switching requirement portion 14 to transmit the command to the AWD 63, and a signal is input from the automatic driving switching switch due to the receiving of the manual driving switching requirement and switching from the automatic driving mode to a manual driving mode is carried out.

At this time, the driving switching control portion 12 switches, in a period until the manual assist release time has elapsed, to the manual driving mode while the AWD 63 gradually or stepwisely returns the right and left distribution to the original drive distribution and in a manner of relatively reflecting the manual driving steering by the driver with respect to distribution change of the right and left distribution (that is, gradually or stepwisely).

In this way, until the manual assist release time defined in advance has elapsed, even if the driver performs a sudden handle operation or an excessive handle operation, the right and left distribution of the vehicle is controlled, and thus the handle operation amount is not completely reflected in the behavior of the vehicle. Then, in a stage when the manual assist release time has elapsed and it is completely transited to the manual driving steering, that is, in a stage when it is completely switched to the manual driving mode, the handle operation according to the intention of the driver is completely reflected in the behavior of the vehicle.

Therefore, in the control system of a vehicle and the control method of a vehicle of the embodiment, when the requirement of switching from the automatic driving to the manual driving is issued due to the disturbance such as that the crosswind is received during the automatic driving and the great yaw rate is generated, the steering amount at the time of the automatic driving is stored, and the manual driving steering is controlled to be gradually (or stepwisely) reflected in the behavior of the vehicle while dealing with the disturbance by switching control of the driving force from the automatic driving steering to the right and left driving force distribution based on the steering correction amount of the stored steering amount, and thereby the disturbance of the vehicle behavior can be avoided/suppressed even if the driver performs a sudden handle operation or an excessive handle operation when the requirement of the switching to the manual driving is issued.

That is, according to the control system of a vehicle and the control method of a vehicle of the embodiment, the disturbance of the vehicle behavior caused by the deviation between the steer⋅AP operation by the automatic driving and the intention of the driver can be avoided/suppressed by switching gradually (or stepwisely) from the automatic driving to the manual driving, and a vehicle with higher safety and reliability can be provided by realizing such advanced vehicle control at the time of switching from the automatic driving to the manual driving.

One embodiment of the control system of a vehicle and the control method of a vehicle according to the disclosure is described hereinabove, but the disclosure is not limited to the one embodiment described above and can be appropriately changed without departing from the scope of the disclosure.

For example, the above “handle operation” means the “steer⋅AP operation”.

What is claimed is:

1. A control system of a vehicle, which is a system for controlling a vehicle at the time of switching from automatic driving to manual driving, comprising:
an abnormality determination portion, which determines whether the vehicle is subject to disturbance and in an abnormal state during the automatic driving;
a manual driving switching requirement portion, which issues a manual driving switching requirement when the abnormality determination portion determines the abnormal state;
a storage portion, which stores a steering amount at the time of the automatic driving when the requirement of switching to the manual driving is issued from the manual driving switching requirement portion;
a driving force distribution control portion, which controls, when the requirement of switching to the manual driving is issued from the manual driving switching requirement portion, switching a driving force of the vehicle to right and left drive distribution according to the steering amount at the time of the automatic driving stored in the storage portion;
a right and left distribution/manual driving transition time measurement portion, which measures a manual assist release time set in advance from a stage in which the driving force of the vehicle is switched to the right and left drive distribution by the driving force distribution control portion; and
a driving switching control portion, which switches the automatic driving and the manual driving to each other, wherein
the driving force distribution control portion and the driving switching control portion are configured that a return control which returns the right and left drive distribution to original driving force distribution is gradually or stepwisely carried out in a period that the manual assist release time has elapsed from a moment when the driving force of the vehicle is controlled to be switched to the right and left drive distribution by the driving force distribution control portion, and the control in which the manual driving steering is reflected in the behavior of the vehicle is gradually or stepwisely carried out.

2. A control method of a vehicle, which is a method to control a vehicle at the time of switching from automatic driving to manual driving, and which
changes driving force distribution of the vehicle to right and left driving force distribution, and
gradually or stepwisely switches to the manual driving while returning the right and left driving force distribution to original driving force distribution.

3. The control method of a vehicle according to claim 2, wherein
when a requirement of switching from the automatic driving to the manual driving is issued, a steering amount at the time of the automatic driving is stored,
the driving force distribution of the vehicle is changed to the right and left driving force distribution based on the steering amount at the time of the automatic driving, and
in a period that a time define in advance has elapsed from a moment when the driving force distribution of the vehicle is changed to the right and left driving force distribution, the automatic driving is gradually or stepwisely switched to the manual driving while the right and left driving force distribution is returned to the original driving force distribution.
